(19) United States
(12) Patent Application Publication
(10) Pub. No.: US 2015/0299521 A1
(43) Pub. Date: Oct. 22, 2015

(54) THERMALLY DEBONDABLE TAPE

(71) Applicants: NITTO EUROPE N.V., Genk (BE); NITTO DENKO CORPORATION, Toyohashi, Aichi (JP)

(72) Inventors: Greet BOSSAERT, Opglabbeek (BE); Myriam VANDENHOLT, Diepenbeek (BE); Gijs VANDERSANDEN, Diepenbeek (BE); Bart FORIER, Lummen (BE); Tatsuya SUZUKI, Hasselt (BE)

(73) Assignees: Nitto Denko Corporation, Toyohashi, Aichi (JP); NITTO EUROPE N.V., Genk (BE)

(21) Appl. No.: 14/439,483

(22) PCT Filed: Nov. 4, 2013
(86) PCT No.: PCT/EP2013/003314

§ 371 Date: Apr. 29, 2015

(30) Foreign Application Priority Data
Nov. 2, 2012 (EP) 12007481.0

(51) Int. Cl. C09J 7/04

(52) U.S. Cl. CPC C09J 7/041; C09J 2433/00; C09J 2400/22; C09J 2461/00; C09J 2401/005; C09J 2201/134; C09J 2203/326; C09J 2201/36

(57) ABSTRACT

The present invention refers to a thermally debondable tape having a base adhesive layer and at least one thermally releasable adhesive layer including an adhesive and thermally expandable particles. The debondability even after long term storage or use shall be enhanced. In this regard the base adhesive layer has a lower adhesion at expansion temperature of the thermally expandable particles than at room temperature.

The present invention relates to a thermally expandable tape having a base adhesive layer and at least one thermally releasable adhesive layer comprising an adhesive and thermally expand-able particles.

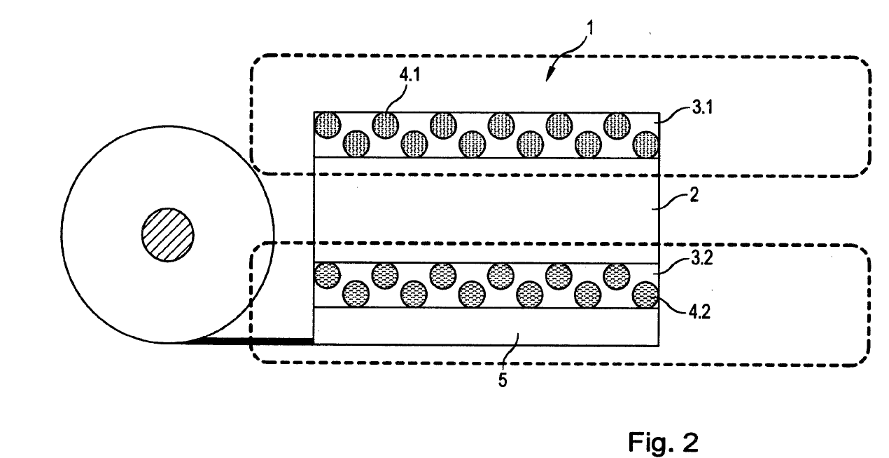

Such a tape is for example known from EP 1 889 887 A1, which describes with reference to FIG. 2 an adhesive sheet having a substrate and disposed on one side an adherent layer having two layers composed of a resin layer containing heat expendable microspheres and an adhesive layer. Preferably a release film is attached to the adhesive layer until the adhesive sheet is used. Besides the use of such adhesive sheets in the manufacturing of small electronic parts as for example in ceramic capacitors etc, it is also known to use such tapes for any kind of easy separation of parts by heating, for example, after storage or use when disassembled for recycling or reworking. Further uses of similar tapes which can also be heat released are described in EP 2 423 285 A1 and EP 2 423 286 A1 as well as in EP 0 527 505 B1 and EP 1 814 703 B1.

EP1 724 320 A1 relates to a heat-peelable adhesive sheet comprising a substrate and a heat-expandable pressure-sensitive adhesive layer arranged on or above at least one side of the substrate, wherein the heat-expandable layer contains a foaming agent and has a shear modulus (23° C.) in an unfoamed state of 7×10⁶ Pa or more, and wherein adhesive sheet further comprises a pressure-sensitive adhesive layer being arranged on or above the heat-expandable , pressure-sensitive adhesive layer having a shear modulus (23° C.) of less 7×10⁶ Pa.

EP 2 080 793 A1 discloses a thermally-foamable re-releasable acrylic pressure-sensitive adhesive tape or sheet comprising a microparticle-containing viscoelastic substrate, and a thermal foaming agent-containing pressure-sensitive adhesive layer provided on at least one surface of the microparticle-containing viscoelastic substrate.

JP 63 186791 A discloses an expandable pressure-sensitive adhesive sheet comprising a substrate, a pressure-sensitive adhesive sheet containing a foaming agent, and a pressure-sensitive adhesive layer which forms the exterior layer.

The problem with such tapes is that even after a long term use of such tapes in bonding surfaces together it is required that an easy separation from the bondage surface is still possible and that storage or use conditions may not negatively influence the bonding ability too much. Of course, ageing of adhesives is always a problem because the adhesion force tends to increase in time but under normal conditions of storage or use at room temperature even over an extended period of time, the objective is that a good debondability shall still be given.

An object of the present invention is to provide a thermally debondable tape according to the preamble of claim 1 that permits an enhanced and easy separation even after long term storage or use.

In order to achieve the above mentioned objective, the present invention provides for a thermally debondable tape according to claim 1. The base adhesive layer (2) has an adhesion of less than 2 N/20 mm at expansion temperature of the thermally expandable particles (4.1, 4.2), and an adhesion of more than 10 N/20 mm at 20° C. Preferably the adhesive of the thermally releasable adhesive layer (3.1, 3.2) is harder than the adhesive composition of the base adhesive layer (2). The gel content of the thermally releasable layer (3.1, 3.2) is at least 90%, a value which may be achieved by measures available to the average practitioner, typically by iso-cyanate cross-linking or any other suitable cross-linking method. According to the invention, the thermally debondable tape has at least two layers (a base adhesive layer and a thermally releasable adhesive layer), wherein the base adhesive layer which does not contain the thermally expandable particles and both layers have specific characteristics as illustrated herein. The result of debondability of such a tape is a combination of the characteristics of these two layers and not just of the thermally expandable particles in the thermally releasable adhesive layer, but also the base adhesive layer enhances the debondability at higher temperatures providing for a synergistic effect in this regard. As far as the prior art references refer to a lower adhesive layer strength at higher temperature, it is always referred to the state after heat expansion of the thermally expandable particles. According to the present invention, the lower adhesion at higher temperature shall be even given without the aid of the expansion of the thermally expandable particles. Preferably, the adhesion of the base adhesive layer decreases over the whole range between room temperature and the expansion temperature of thermally expandable particles. The inventive characteristics of the base adhesive layer gives the person skilled in the art an opportunity to carry out an optimization of the thermally releasable adhesive layer and its composition so that an excellent initial adhesion (at room temperature, i.e. 20° C.) might be given.

Any references to the room temperature in the sense of the present invention are a reference to 20° C.

The thermally debondable tape may have additional layers, for example a bubble-bearing micro particle-containing visco elastic layer to provide for level difference-absorbing efficiency or shock absorbing efficiency along with other advantages. The base adhesive layer has an adhesion of less than 2 N/20 mm, preferably less than 1 N/20 mm, preferably 0 N/20 mm at expansion temperature of the thermally expandable particles. The initial adhesive strength can be determined in accordance with testing the pressure sensitive tapes and sheets in accordance to EN 1939 (2003) by bonding the tape having the base adhesive layer under pressure to an adhered plate, preferably a polycarbonate or BA steel plate under the condition of a load of 2 kg roller and separating the tape sample in the peeling direction at an angle of 180° and a tensile speed of 300 mm/min by using a tensile tester. This will be done under stable temperature and humidity conditions, i.e. typically room temperature and a RH of 50%. The values defined show that at expansion temperature, for example 150° C., the base adhesive layer only provides for a minor adhesion and this supports the debonding at the time the thermally expandable particles expand in the thermally releasable layer. Due to this decrease in adhesion, the base adhesive layer also does not restrict the expansion of the thermally expandable particles in the vicinity of this layer.

The base adhesive layer may be constituted by a single adhesive layer, in embodiments however the base adhesive layer may comprise two base adhesive layers sandwiching a support layer. In such an embodiment the base adhesive layer has the structure of a double sided adhesive tape with a support layer, and such a configuration may offer advantages in particular if higher mechanical requirements are to be met.

The adhesive strength at the expansion temperature is also measured accordance to EN 1939 (2003), using the respective expansion temperature. The actual expansion temperature of course depends on the materials employed. For commercial materials used as the thermally expandable particles the expansion temperature defined herein is the expansion initiation temperature indicated by the manufacturer (if a range is given the highest value is taken). A preferred expansion temperature for comparison with the adhesion at 20° C. in the sense of the present invention is at least 100° C., more preferably at least 150° C., and in embodiments up to 220° C. Otherwise, the expansion temperature referred to herein is the temperature as determined by DSC.

According to an embodiment, it is also important that the initial adhesion of the tape at 20° C., i.e. room temperature, is sufficiently high. The base adhesive layer has an adhesion of more than 10 N/20 mm and is preferably more than 12 N/20 mm at room temperature and by using a BA steel plate as the substrate as measured accordance to EN 1939 (2003).

In one embodiment, a composition of the base adhesive layer having a total glass transition temperature (Tg) of less than −30° C., preferably less than −40° C. is employed. The combination of composites leads preferably to a base layer which is softer than the thermally releasable layer. The concepts of softness and hardness as referred to herein can be considered as relationship of the glass transition temperatures of the materials concerned. A harder material is typically associated (and can accordingly be shown thereby) with a higher glass transition temperature, while softness refers to a material with a lower glass transition temperature.

Glass transition temperature (as well as other thermal transition temperatures such as melting temperatures, unless indicated otherwise) are determined using DSC with a heating and cooling rate of 10° C. per minute using standard equipment.

The base adhesive layer may have a lower adhesion at higher temperatures, i.e. at temperatures above room temperature but below the herein specified expansion temperature. Preferably, the adhesive layer has a lower adhesion at 80° C., as compared to the adhesion at 20° C. The adhesion is measured in accordance to EN 1939 (2003). Typically however it is sufficient if the base adhesive layer shows the temperature dependent adhesiveness as defied in claim 1.

Tests have shown that a harder shell polymer is advantageous in providing a proper functioning of the thermal expansion at the expansion temperature. Therefore, the shell polymer of the thermally expandable particle has preferably a Tg of more than 100° C., preferably more than 105° C., as determined using the above-mentioned method. The shell substance does not soften even under high temperatures, i.e. temperatures above room temperature but below the expansion initiation temperature for extended periods of time, making the particles show considerable expansion efficiency without permeation or diffusion of the substance that gasifies and expands by heating under expansion temperature. Samples of the commercial products of the heat expandable particles or microsphere include but are not particularly limited to the trade-name: “Matsumoto Microsphere F-80S” (shell-substance glass transition temperature: 110° C. and expansion initiation temperature: 140-150° C.), “Matsumoto Microsphere F-190D”, (expansion initiation temperature: 160-170° C.), “Matsumoto Microsphere F-230D”, (shell-substance glass transition temperature: 197° C. and expansion initiation temperature: 180-190° C.) and “Matsumoto Microsphere F-260D”, (expansion initiation temperature: 190-200° C.), (manufactured by Matsumoto Seiyaku Co. Ltd); and “Expancel microsphere 920DU40” (expansion initiation temperature: 123-133° C.), (manufactured by Expancel) and the like.

The amount of thermally expandable particles used in the thermally releasable adhesive layer may vary depending on the kind thereof but generally is 10-200 parts by weight, preferably 20-125 parts by weight, more preferably 25-100 parts by weight, with respect to 100 parts by weight of all monomer components of the thermally releasable adhesive layer. An amount of less than 1 parts by weight may prohibit effective reduction of the adhesive power of the heat treatment while an amount too high may cause cohesive failure of the thermally releasable adhesive layer or fracture at the interface with the base adhesive layer 2.

The thermally expandable particles are typically polymeric particles as described in illustrative embodiments later filled with an heat expandable liquid or gaseous component, also exemplified later.

The average diameter of the heat expandable particles is generally preferably 1-80 micrometers, more preferably 3-50 micrometers from the points of dispersability and thin layer forming efficiency.

In a further variant of the thermally debondable tape, the adhesive of the thermally releasable adhesive layer is harder than the adhesive composition of the base adhesive layer. This refers to the base material of the base adhesive layer and excludes re-enforceable elements, like inlays, webs, meshs etc. This enhances the effect that the extension of the thermally expandable particles is not restricted by the base adhesive layer

The gel content of the composition of the thermally releasable adhesive layer is at least 90%, preferable at least 94%, more preferably at least 95%, such as from 95% to 99%. Such gel contents may be achieved by measures available to the average practitioner, typically by iso-cyanate crosslinking or any other suitable cross-linking. The gel content of the base adhesive layer is preferably at least 50%, more preferably at least 60% by iso-cyanate cross-linking or any suitable cross-linking.

Surprisingly it has been found that a preferred balance of properties (i.e. high and stable initial adhesion and good debondability after heat treatment) can in particular be achieved if the gel content of the thermally releasable layer is within the specified range, in particular in the range of from 95 to 99%, more preferable 95 to 98%. Lower gel contents surprisingly did result in inferior debondability. The high gel content preferred in the present invention may be achieved by appropriately selecting the crosslinking processes, for example by increasing the amount of iso-cyanate based crosslinker to 4 wt % or more.

The gel content as referred to herein is determined as follows: 1 g of the respective material is precisely weighed and is dipped in about 40 ml ethyl acetate for 7 days at room temperature. The portion insoluble in the solvent is filtered off and is entirely dried at 130° C. for 2 hours and the dry weight of the insoluble fraction is determined, allowing the calculation of the gel content (%).

In order to provide for a thermally debondable tape to have thermally releasable adhesive layers which might be directly attached to the components to be bonded by the tape, in a further embodiment, the thermally debondable tape comprises of a second thermally releasable adhesive layer, whereby the base adhesive layer is disposed between the two thermally releasable adhesive layers. Such a tape design makes sure that at least three layers work together to decrease the adhesion at expansion temperature in order to provide for a good separation of the composition of the components to be bonded even after long term storage or use.

Preferably, the thermally releasable adhesive layer is one as described in EP0527505 B1 (page 2, line 44-page 5, line 10).

Preferably, the base adhesive layer comprises an acrylic polymer. Examples of such polymers are given in EP 1 889 887 A1 (page 6, line 40-page 7, line 53).

In a further embodiment, the thermally releasable adhesive layer or at least one of the two thermally releasable adhesive layers might be covered by a release liner. Examples for such a release liner (separator) are also given in EP 1 889 887 A1.

In preferred embodiments the adhesive compositions employed in the base layer as well as in the thermally releasable layer are based on acrylic adhesives. Preferred is also a constitution of the base layer with two base adhesive layers sandwiching a support layer. Further preferred is a constitution wherein the base layer and the thermally releasable layer do show a difference in hardness as explained herein. These specific embodiments as well as all other preferred embodiments as given herein may be provided singly or in any combination of two or more thereof.

In the following, an embodiment of the present invention is described by the use of drawings. The drawings show:

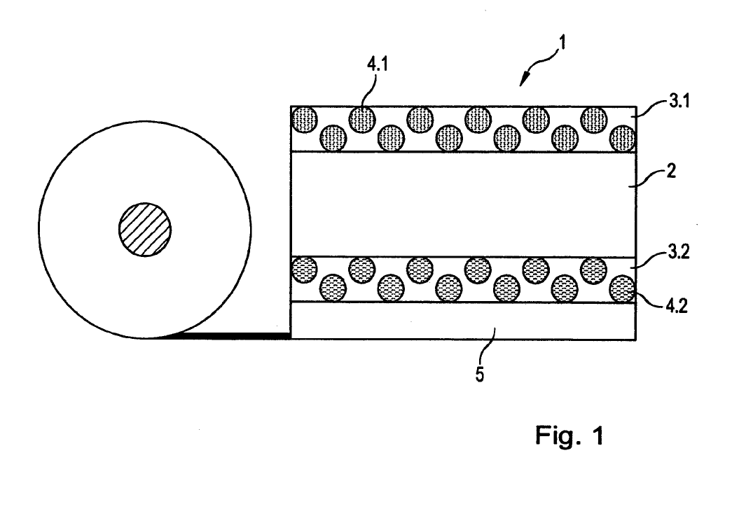

FIG. 1 is a diagrammatic sectional view illustrating an embodiment of the thermally debondable tape of the inventions.

FIG. 2 is a diagrammatic sectional view illustrating the same embodiment as in FIG. 1 which emphasises the thermally releasable adhesive layers.

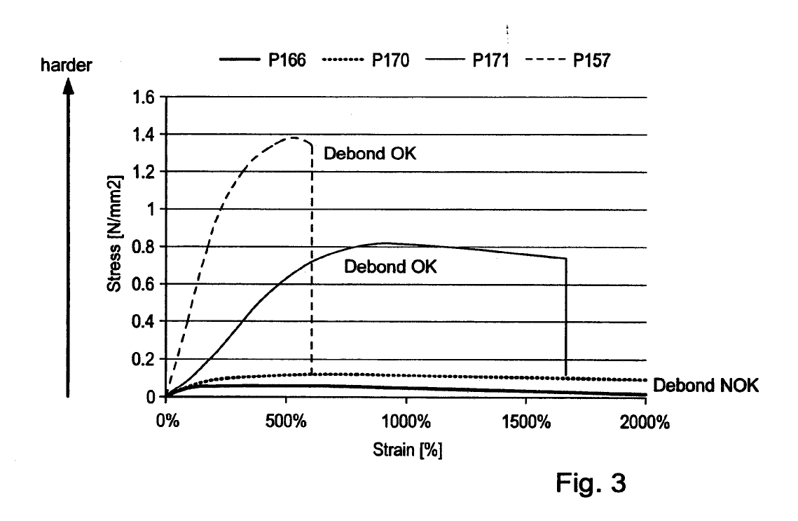

FIG. 3 is a diagram showing the relation between stress and strain dependent on the hardness of the thermally releasable adhesive layers.

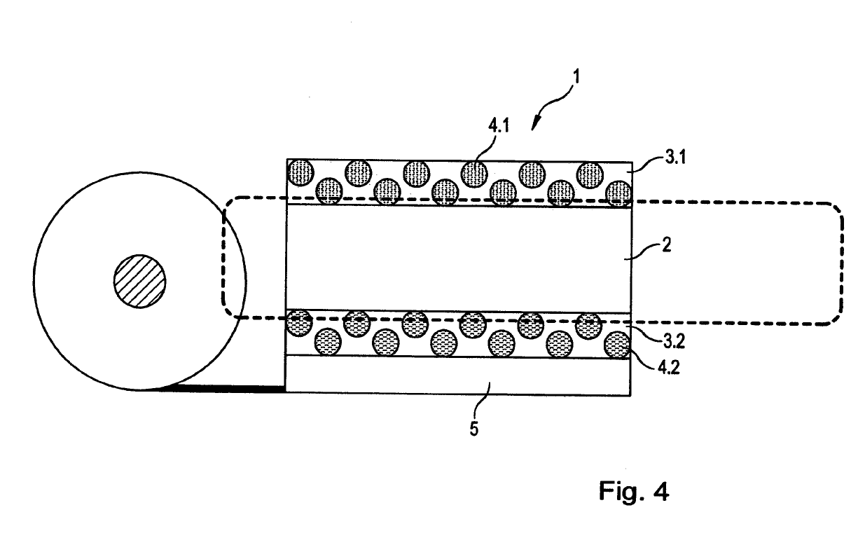

FIG. 4 is a diagrammatic sectional view illustrating the embodiment shown in FIG. 1, wherein the base adhesive layer is emphasised.

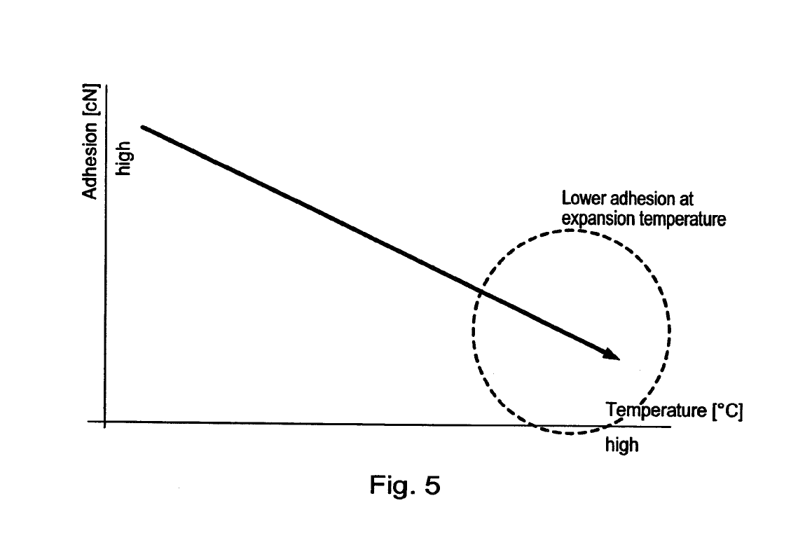

FIG. 5 is a concept diagram showing the gained relation between adhesion and temperature for the base adhesive layer.

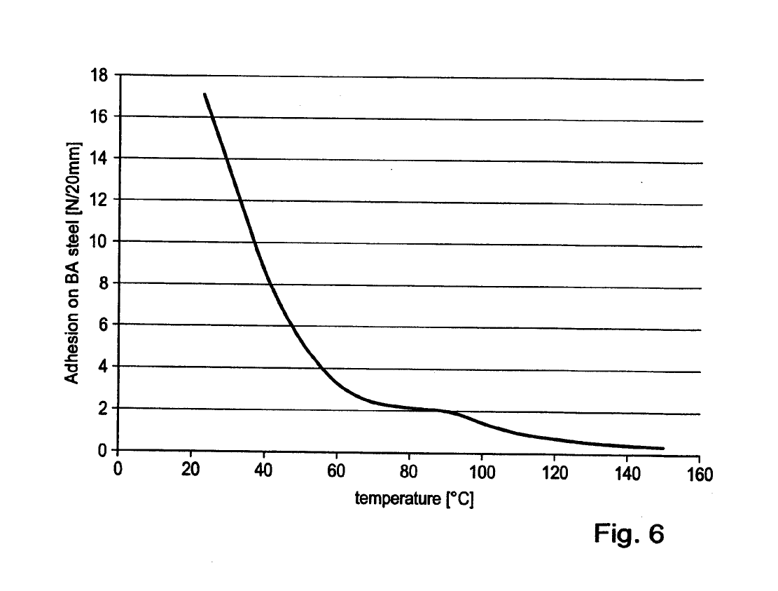

FIG. 6 is a diagram showing a specific example of the relation between the adhesion and the temperature of the base adhesive layer.

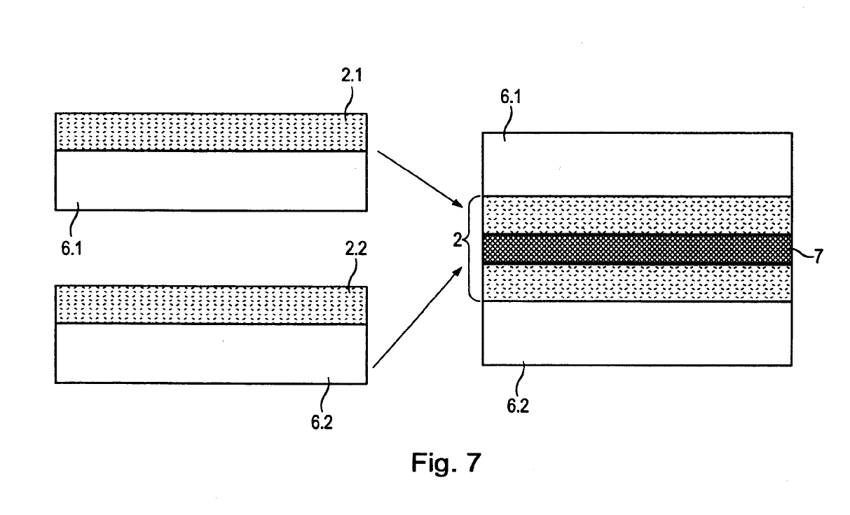

FIG. 7 is a diagrammatic sectional view illustrating an embodiment of the preparation of the base adhesive layer.

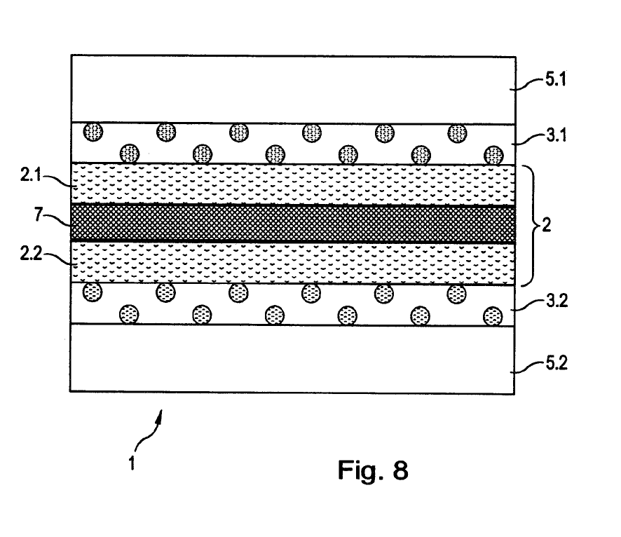

FIG. 8 is a diagrammatic sectional view illustrating an embodiment of the preparation of the thermally releasable tape which uses the base adhesive layer as shown in FIG. 7.

The thermally debondable tape 1 includes a base adhesive layer 2 and preferably on both sides thereof a thermally releasable adhesive layer 3.1 and 3.2 containing heat expandable particles 4.1 and 4.2 in the form of microspheres. The surface of the thermally releasable layer 3.2 opposite to the base adhesive layer 2 is covered by a release liner 5 which is later on removed for use of the thermally debondable tape 1.

The thermally debondable tape 1 may be, as described above, a double sided adhesive sheet having adhesive faces on both faces or a single sided adhesive sheet (single sided adhesive tape) having an adhesive face only on one side. The thickness of the base adhesive layer 2 is not particularly limited, and can be selected properly, for example, according to the object and the use method.

In addition, the thermally debondable tape 1, according to the present invention, may be prepared in the state in which it is rolled around a roll or in the state which the sheets thereof are piled. Specifically, the tape 1 may have the shape of a sheet or a tape or the like. The release liner 5 is advantageous if wound to a roll so that the adhesive face is protected with the release liner. Examples of release coated agents which are used when a release liner is formed on the face of the substrate include silicon based agents, long chained alkyl acrylate based release agents and the like.

The base adhesive layer 2 may preferably be in the form of a multilayer structure formed of two of adhesive layers 2.1, 2.2 laminated onto a base support layer 7. The adhesive layers 2.1 and 2.2. preferably sandwich the base support layer, as illustrated in FIGS. 7 and 8. The base support layer 7 is preferably formed from a material such as non-woven material, or from known supports materials for adhesive tapes, such as polymeric films as well as metyl foils.

The thermally releasable adhesive layers 3.1 and 3.2 are not particularly limited by their hardness. Usually it is a layer of an acrylic adhesive containing thermally expandable particles 4.1 and 4.2 and it normally has an acrylic polymer as the base polymer. The base polymer of the thermally releasable adhesive layers 3.1 and 3.2 might be the same as of the base adhesive layer 2 or different therefrom. The thermally debondable tape 1, according to the present invention, has a property that is thoroughly adhered to the adhered yet is easily separated from the adhered under heat.

The adhesive composition of thermally releasable adhesive layer 3.1 and 3.2 comprise preferably an acrylic monomer as a principal monomer component.

The thermally expandable particles 4.1 and 4.2 contain a substance that expands easily by gasification under heat such as isobutene, propane and pentane in shells (outershell) of an elastic (polymeric) shell substance.

Examples of the shell substances (shell forming substance) for the thermally expandable particle used in the present invention include vinylidene chloride- acrylonitile copolymers, polyvinyl alcohol, polyvinylbutyral, polymethyl methacrylate, polyacrylonitrile, polyvinylidine chloride, polysulfone and the like. The glass transition temperature (Tg) of the thermally expandable particles 4. 1 and 4.2 is preferably 100° C. or higher, more preferably higher than 105° C., preferably not higher than 200° C. and more preferably not higher than 180° C. as determined using the abovementioned method. When the glass transition temperature is 100° C. or higher, the thermally debondable tape 1 efficiently expands thermally even under storage at high temperature for an extended period of time and thus it is easy to control the 180° peel adhesive strengths of the storage in an atmosphere of 80° C. for two months and heat treatment at expansion temperature. As a result, it is possible to separate or disassemble the thermally debondable tape 1 easily even after long term storage or use by using particles 4.1 and 4.2 with a shell substance having a glass transition temperature of 100° C. or higher, the shell substance does not soften even after storage for an extended period of time, making the particles show thermal expansion efficiency even after long term storage or use.

The average diameter of the heat expandable particles 4.1 and 4.2 is generally preferably 1-80 micrometers, more preferably 3-50 micrometers from the point of dispersability and thin layer forming efficiency.

The thermally expandable particles 4.1 and 4.2 have favourable strength making it resistant to bursting until the co-efficient of volume expansion become 5 times or more, particularly 10 times or more, for efficient reduction of the adhesive power of the thermally releasable adhesive layers 3.1 and 3.2 by heat treatment at expansion temperature. If thermally expandable particles 4.1 and 4.2 are used that burst at low volume expansion co-efficient, it is not possible to reduce the adhesive area between the thermally releasable adhesive layers 3.1 and 3.2 and the adhered sufficiently by heat expansion treatment and thus to obtain favourable releasability.

The amount of thermally releasable particles 4.1 and 4.2 used may vary depending on the kind thereof but is 10-200 parts by weight, preferably 20-125 parts by weight, more preferably 25-100 parts by weight, with respect to 100 parts by weight of all monomer components of the thermally releasable adhesive layers 3.1 and 3.2. An amount of less than 1 parts by weight may prohibit effective reduction of the adhesive power of the heat treatment while an amount of more than 100 parts per weight may cause cohesive failure of the thermally releasable adhesive layers 3.1 and 3.2 or fracture at the interface with the base adhesive layer 2.

Examples of composition of thermally releasable adhesive layers 3.1 and 3.2 are given on page 2, line 44-page 5, line 10 of EP 0527505 B1. Alternatively to a solvent-polymerisation system an UV-polymerisation system (e.g. page 7, line 8-page 14, line 6 of EP 2 423 286 A1) can be used. However, the invention is not particularly limited to these technologies.

The composition of the base adhesive layer 2 might be similar to the adhesive composition of the thermally releasable adhesive layers 3.1 and 3.2 except the thermally expandable particles 4.1 and 4.2. It is however, important to note that differences exist. The adhesive composition of the thermally releasable adhesive layers 3.1 and 3.2 (except the thermally expandable particles 4.1 and 4.2) is harder than the composition of the base adhesive layer 2.

FIG. 3 shows the relation between hardness of the adhesive composition of the thermally releasable layers 3.1 and 3.2 and the ability to debond properly. The harder the adhesive composition is the less strain is possible but the better the debondability is. The diagram shows curves marked with P166, P170, P171 and P157 showing increasing hardness. The reason for this effect is that the adhesive fluidity is higher the softer the adhesive composition is and it could refill the gap in between the thermally expandable particles 4.1 and 4.2. As a result the surface of the thermally releasable layer stays relatively smooth even after treatment at expansion temperature whereas it is rougher as the harder the adhesive composition is as long as the adhesive composition does not hinder expansion of the particles 4.1 and 4.2 at all. A rougher surface leads to a good debondability.

The base adhesive layer 2 shall at best have the characteristic as shown in FIG. 5 and it shall provide for a high adhesion at 20° C., i.e. at room temperature, and a lower adhesion at expansion temperature. At best the base adhesive layer 2 has an adhesion of less than 2 N/20 mm, preferably less than 1 N/20 mm, preferably 0 N/20 mm at expansion temperature (for example 150° C.) of the thermally expandable particles 4.1 and 4.2. In order to provide for sufficient adhesion at room temperature, the base adhesive layer 2 has preferably an adhesion of more than 10, preferably more than 12 at room temperature (see a specific example as shown FIG. 6). Testing was carried out on a BA steel using a strip having a width of 20 mm and using the above described testing methods.

Preferably, the base adhesive layer 2 comprises and acrylic polymer 2 having a glass transition temperature (Tg) of less than −30° C., preferably less than −40° C. It comprises a first additive having a softening point in the range of 85° C.-105° C., preferably in the range of 92.5° C.-97.5° C., in the present case exactly 95° C. The base adhesive layer 2 also contains a second additive which is liquid at room temperature. The base adhesive layer 2 may also comprise of a third additive having a melting point in the range of 75° C.-95° C., preferably 82.5° C.-87.5° C. In the present case it is 85° C. (determined by the ring and ball method). The gel contents of the composition of the thermally releasable layers 3.1 and 3.2 are at least 95%, by iso-cyanate cross-linking.

The amount of the isocyanate crosslinking agent in the composition is preferably at least 4 parts by weight, more preferably at least 5 parts by weight, based on the total weight of the composition forming the layers. Moreover, the amount of the isocyanate crosslinking agent in the composition is preferably 12 parts by weight or less, more preferably 10 parts by weight or less, based on the total weight of the composition forming the layers.

This composition leads to exactly the curve as shown in FIG. 6 and provides for a substantial adhesion drop toward the expansion temperature and therefore enhances debondability of the thermally debondable tape 1. In order to simulate long term aging or use of the bonds of the thermally debondable tape 1, it is stored under specific temperature conditions for a certain amount of time (e.g. initially 15 days, one month, 8 weeks, 12 weeks, 16 weeks etc). Temperatures used for aging are for example, 40° C., 50° C., 70° C. or 80° C. Initial testing and testing after ageing is done by measuring the adhesion first at room temperature and heating the tape to expansion temperature. It is then evaluated whether the tape debonds properly (e.g. completely or not). Testing is done with adherent partners such as thermal plastic materials and metal material, preferably BA steel. Although the preferred embodiment has been shown with regard to a four layered thermally debondable tape 1, the tape may include further layers or re-enforcement means, like webs, meshes, fabrics etc, or additional base layers. The tape 1 may also include, in addition, a layer comprising a bubble bearing microparticle containing visco-elastic material as this described on page 14, line 8-21, line 51 of EP 2 423 286 A1.

In a further preferred embodiment the base adhesive layer does directly follow the thermally releasable layer(s), i.e. there are now intermediate layers between these two layers.

The present invention will be illustrated with the following examples. The invention should however not be limited thereto.

Example (with reference to FIGS. 7 and 8):

The adhesive composition of the base adhesive layer 2 is a mixture of
an acrylic co-polymer (base polymer),
triethylene glycol ester of partially hydrogenated resin,
terpene phenolic resin,
modified aromatic hydrocarbon resin, and
isocyanate crosslinking agent.

The acrylic co-polymer has a molecular weight of 350,000 (determined as disclosed in US 2010 0028671 A1) and a Tg of −48° C.

In a first step, this adhesive composition was coated on a paper release liner 6.1, 6.2 and cured at 130° for 3 minutes. Dried thickness of the adhesive layers 2.1, 2.2 is 50 mm. The release liner 6.1, 6.2 has a thickness of 120 mm.

In a second step, two of the adhesive layers 2.1, 2.2 as prepared in the first step, were laminated onto a non-woven material having a weight of 13 g/m² so as to form a base adhesive layer 2.

The adhesive composition of the thermally releasable adhesive layers 3.1, 3.2 is a mixture of
an acrylic co-polymer (base polymer),
thermally expandable particles F80SD (Matsumoto Yushi),
terpene phenolic resin,
modified aromatic hydrocarbon resin, and
iso-cynanate crosslinking agent.

The acrylic co-polymer has a molecular weight of 350,000 and a Tg of −48° C.

In a third step, this adhesive composition was coated on a paper release liner 5.1, 5.2 and cured at 80° C. for 3 minutes. Dried thickness of the layers 3.1, 3.2 is 50 mm. The paper release liner 5.1, 5.2 has a thickness of 120 um.

In a fourth step, the two release liners 6.1, 6.2, were removed form the base adhesive layers 2.1, 2.2, and two thermally releasable layers 3.1, 3.2, each coated on a paper release liner 5.1, 5.2, as produced in the third step were laminated on to the base adhesive layer 2 resulting in the thermally debondable tape (1). The two paper release liner 5.1, 5.2, forming the upper and lower side of the thermally debondable tape (1).

The gel content of the adhesive composition of the base adhesive layer 2 is 60%. The gel content of the thermally releasable layer 3.1, 3.2 is 95%. The adhesion of the thermally releasable tape 1 is 10.8 N/20 mm at 23° C. and 0.5 N/20 mm at 150° C. The debondabiltiy on BA steel at 70° C. and 12 weeks ageing as well as at 80° C. and 8 weeks ageing is ok.

1. A thermally debondable tape having a base adhesive layer and at least one thermally releasable adhesive layer comprising:
an adhesive and thermally expandable particles, characterized in that the base adhesive layer has an adhesion of less than 2 N/20 mm at expansion temperature of the thermally expandable particles, and
an adhesion of more than 10 N/20 mm at 20° C.;
wherein the gel content of the thermally releasable layer is at least 90%.

2. The thermally debondable tape according to claim 1, characterized in that the base adhesive layer has an adhesion of less than 1 N/20 mm, at the expansion temperature of the thermally expandable particles.

3. The thermally debondable tape according to claim 1, characterized in that the base adhesive layer has an adhesion of more than 12 N/20 mm at 20° C.

4. The thermally debondable tape according to claim 1, characterized in that the composition of the base adhesive layer having a total glass transition temperature (Tg) of less than −30° C., preferably less than −40° C.

5. The thermally debondable tape according to claim 1, characterized in that the shell polymer of the thermally expandable particles having a glass transition temperature (Tg) of more than 100° C., preferably more than 105° C.

6. The thermally debondable tape according to claim 1, characterized in that the gel content of the base adhesive layer is at least 50%, preferably at least 60%.

7. The thermally debondable tape according to claim 1, characterized in a further comprising second thermally releasable adhesive layer, whereby the base adhesive layer is disposed between the two thermally releasable adhesive layers.

8. Thermally debondable tape according to claim 1, characterized in that the base adhesive layer comprises an acrylic polymer.

9. The thermally debondable tape according to claim 1, characterized in that the thermally releasable adhesive layer or at least one of the two thermally releasable adhesive layers is coated by a release liner.

10. The thermally debondable tape according to one of claim 1, characterized in that the base adhesive layer does directly follow the thermally releasable layer.

11. The thermally debondable tape according to claim 1, wherein the base adhesive layer has a multilayer structure comprising two adhesive layers provided on the two opposed sides of a base support layer.

12. The thermally debondable tape according to claim 1, wherein the adhesive of the thermally releasable adhesive layer is harder than the adhesive composition of the base adhesive layer.
